(19) United States
(12) Patent Application Publication
(10) Pub. No.: US 2015/0269357 A1
(43) Pub. Date: Sep. 24, 2015

(54) METHOD AND APPARATUS FOR DIGITAL RIGHTS MANAGEMENT THAT IS FILE TYPE AND VIEWER APPLICATION AGNOSTIC

(71) Applicant: Adobe Systems Incorporated, San Jose, CA (US)

(72) Inventor: Salil Taneja, Noida (IN)

(73) Assignee: Adobe Systems Incorporated, San Jose, CA (US)

(21) Appl. No.: 14/220,784

(22) Filed: Mar. 20, 2014

(51) Int. Cl. G06F 21/10; G06F 21/64

(52) U.S. Cl. CPC G06F 21/10; G06F 21/64

(57) ABSTRACT

A computer implemented method and apparatus for file type and viewer application agnostic digital rights management. The method comprises intercepting processing of one or more operating system calls from a viewer application, wherein each of the one or more operating system call requests performance of a function on a digital asset of a plurality of digital assets subject to digital rights management (DRM); performing DRM enforcement of the digital asset with respect to the requested function; and returning processing of the digital asset to the viewer application.

### BACKGROUND OF THE INVENTION

1. Field of the Invention

Embodiments of the present invention generally relate to digital rights management and, more particularly, to digital rights management that is file type and viewer application agnostic.

2. Description of the Related Art

Companies typically maintain documents in a centralized location where the documents may be accessed by employees. Typically, not all employees are permitted to access all of the documents. For example, a company may allow accounting personnel to access payroll documents and allow marketing personnel to access documents related to upcoming projects, but not allow the marketing personnel to print the documents related to upcoming projects because the documents are protected corporate assets. Currently, in order to provide digital rights management (DRM) of digital assets, the digital assets must be encrypted based on the file format of the digital asset. A file format specific application, such as ACROBAT for portable document format (PDF) files, encrypts a digital asset as per the digital asset's file format specification. As such, ACROBAT encrypts PDF files per the specification of the PDF file format. The file format specific application decrypts the digital asset as per the digital asset's file format specification. Once decrypted, a file viewer application is responsible for enforcing DRM restrictions for the digital assets.

Current DRM solutions are typically tied to a specific file format or a specific viewer application. That is, a DRM solution provider must understand all file formats in order to write custom encrypting and decrypting plug-ins that use the file format specification, for all applications that may be used to create and view the digital assets. In addition, the DRM solution provider must provide custom plug-ins that use the file format specification for all applications that may be used to view the digital assets in order to enforce the digital rights associated with the digital assets. Furthermore, the DRM solution provider must create new custom plug-ins as new viewer applications are released. In view of the fact that there are a multitude of different file formats for creating digital assets and different viewer applications for viewing digital assets, DRM becomes an unmanageable task. Therefore, there is a need for a method and apparatus for digital rights management that is file type and viewer application agnostic.

### SUMMARY OF THE INVENTION

The Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A method for digital rights management that is file type and viewer application agnostic is described. The method intercepts processing of one or more operating system calls from a viewer application. Each operating system call requests performance of a function on a digital asset that is subject to digital rights management. The method enforces the digital rights management of the digital asset with respect to the requested function, and when enforcement is complete, returns processing of the digital asset to the viewer application.

In another embodiment, an apparatus for digital rights management that is file type and viewer application agnostic is described. The apparatus comprises a dynamic link library. The dynamic link library intercepts processing of one or more operating system calls from a viewer application. Each of the one or more operating system calls requests performance of a function on a digital asset that is subject to digital rights management (DRM). After enforcing the DRM of the digital asset with respect to the requested function; the dynamic link library returns processing of the digital asset to the viewer application.

In yet another embodiment, a computer readable medium for digital rights management that is file type and viewer application agnostic is described. The computer readable medium stores computer instructions that, when executed by at least one processor causes the at least one processor to perform the method for digital rights management that is file type and viewer application agnostic.

### BRIEF DESCRIPTION OF THE DRAWINGS

FIG. 1 is a block diagram of a system for digital rights management that is file type and viewer application agnostic, according to one or more embodiments;

FIG. 2 depicts a flow diagram of a method for digital rights management that is file type and viewer application agnostic as performed by the DLL of FIG. 1, according to one or more embodiments; and

FIG. 3 depicts a flow diagram of a method for performing DRM enforcement as performed by the DLL of FIG. 1, according to one or more embodiments.

While the method and apparatus is described herein by way of example for several embodiments and illustrative drawings, those skilled in the art will recognize that the method and apparatus for digital rights management that is file type and viewer application agnostic is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for digital rights management that is file type and viewer application agnostic defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Techniques are disclosed for digital rights management (DRM) that is file type and viewer application agnostic. An executable process is created to encrypt the digital assets of a company. The digital assets reside in a repository of the company that may be accessed by a plurality of users. One or more digital assets may also reside on a client computer. The executable process is format agnostic that encrypts all digital assets irrespective of format type in a similar manner. A dynamic link library (DLL) is created that intercepts DRM related operating system calls from a viewer application, such as calls to open a file, edit the file, print, and the like. When the DLL intercepts a call from a viewer application, for example, to open a digital asset, the DLL identifies the user of the application, and determines whether the user has permission to open the digital asset. If the user has permission, the DLL retrieves a decryption key and decrypts the file for use by the user. Similarly, if the user attempts to print a digital asset, the DLL intercepts the print call from the viewer application, identifies the user, determines whether the user has permission to print, and if so, allows the viewer application to proceed with printing.

As used herein and in addition to publicly known or dictionary meaning, a digital asset is any protected file. Different users have different permission rights for accessing a given digital access. The digital asset, in addition to publicly known or dictionary meaning, may be an image, a video, a document, and the like in any file format, created by any software application. A viewer application, in addition to publicly known or dictionary meaning, is any application that may be used to access a digital asset.

As previously explained, existing solutions for encryption and decryption are tied to a specific viewer application or a specific file format, making DRM an unmanageable task. A DRM solution provider must write custom plug-ins for all applications in use and according to all file formats. For example, a PDF document is encrypted per the specification of the PDF file. A Word document is encrypted per the specification of the Word file. As such, the DRM solution provider must create a first plug-in for ACROBAT for decrypting PDF documents and a second plug-in for MICROSOFT Word for decrypting Word documents. When a user wishes to access a protected PDF file, the ACROBAT application must determine digital rights of the user and then decrypt the PDF file per the PDF specification. Similarly, when the user wishes to access a protected Word file, the MICROSOFT word application must determine digital rights of the user and then decrypt the Word file per the Word specification. Each enforcement/decryption mechanism is application specific. As such, existing DRM solutions make it impossible to create a file format agnostic solution for the DRM solution provider. In addition, the DRM solution provider must create new custom plug-ins as new applications are released.

Thus, and in accordance with an embodiment of the present invention, techniques are provided herein that allow for a methodology for file type and viewer application agnostic digital rights management. An encryption program is created using a software development kit. The encryption program resides on a company's server and encrypts all digital assets of a company that are to have their rights managed. The encryption is independent of a file format of the digital asset. In other words, each file is encrypted using the same encryption program regardless of the file format of the digital access. As such, a PDF file is encrypted using the same encryption mechanism as a Word document. The encryption program may be a batch process, a service process or a plug-in to an application that can encrypt the digital assets without any knowledge of file format. The encryption program may provide options such as auto-protecting a particular file format, protecting all file formats of digital assets that are grouped together for storage in a particular directory of memory, and the like. The encryption program may also reside on a client device and be used to encrypt digital assets that are stored on the client device.

The embodiments also create a function patching program for intercepting system calls by a viewer application that are made to perform a function with the digital asset. The embodiments use function patching to replace a function (i.e., an operating system call from a viewer application) with a custom implementation. Function patching is accomplished by creating a dynamic link library (DLL) that intercepts operating system calls for the digital asset from a viewer application. The DLL includes patches for functions the DRM solution wants to restrict. For example, if a DRM solution wants to restrict the printing function of a document, then the DLL patches print related application programming interfaces (APIs) of an operating system that are called to carry out the print function. Thus, when an operating system call is intercepted by the DLL, the DLL determines whether a user has permission to print the document. The patched print function allows printing if the user has permission, but may return an error if a user does not have print permission on the document. The DLL is agnostic to a digital asset's specific application. The digital assets are encrypted using the encryption program (i.e., a same encryption mechanism) regardless of the file format of the digital asset. As such, a file format-specific encryption mechanism is not required by each specific application. Therefore, a specific application no longer requires a specific decryption mechanism to enforce digital rights on digital assets accessed by the specific application. Hence, the DLL is created that is agnostic to the digital asset's specific application. Because the PDF file and the Word file were both encrypted using a same encryption program, ACROBAT includes the same DLL as MICROSOFT Word to enforce the DRM and decrypt the files. Hence, the DRM is independent of file format. A single DLL is created for use by any application that accesses protected digital assets.

Advantageously, the present invention may be implemented with any DRM solution, such as ADOBE® LIVECYCLE® Rights Management such that DRM is viewer application and file format agnostic. No changes or plugins are required in an asset creating or viewing application for supporting DRM. Thus, the present invention makes DRM easily scalable by placing the enforcement function of DRM with the DRM solution, rather than upon coordination between the creating and viewing application.

Various embodiments of a method and apparatus for digital rights management that is file type and viewer application agnostic are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description that follow are presented in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

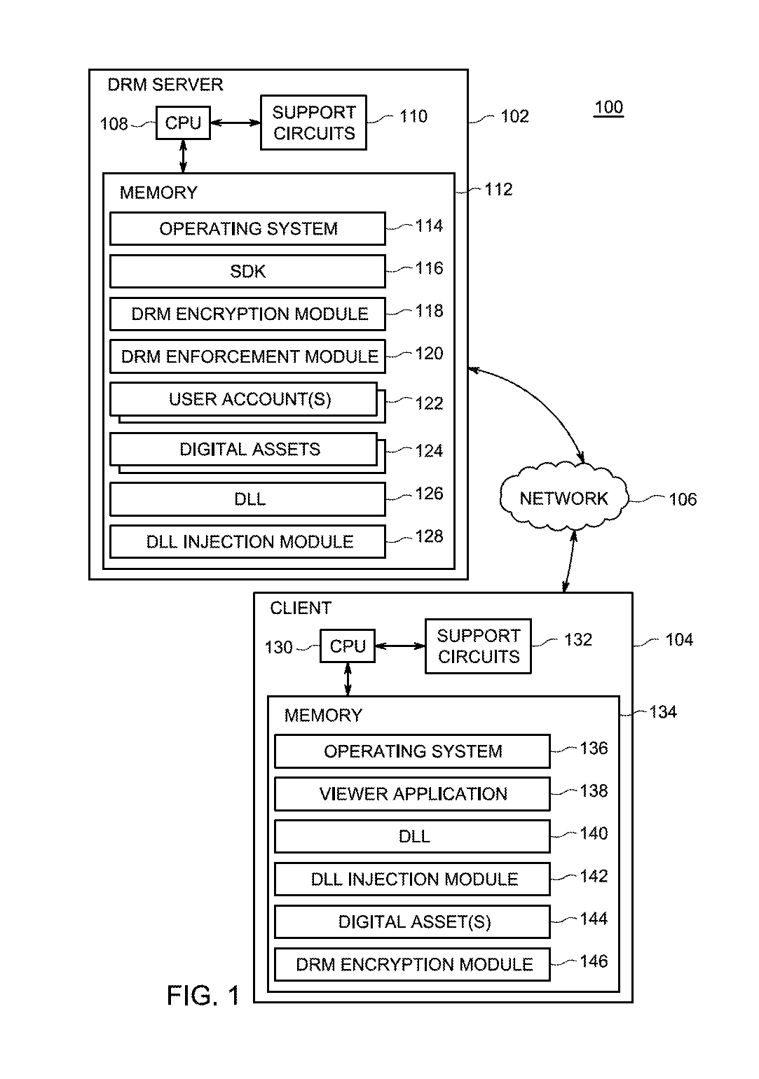

FIG. 1 is a block diagram of a system 100 for digital rights management that is file type and viewer application agnostic (DRM), according to one or more embodiments. The system 100 includes a DRM server 102 and a client 104, communicatively coupled to one another via a network 106. The DRM server 102 is a computing device, for example a desktop computer, laptop, tablet computer, and the like. The DRM server 102 includes a Central Processing Unit (CPU) 108, support circuits 110, and a memory 112. The CPU 108 may include one or more commercially available microprocessors or microcontrollers that facilitate data processing and storage. The various support circuits 110 facilitate the operation of the CPU 108 and include one or more clock circuits, power supplies, cache, input/output circuits, and the like. The memory 112 includes at least one of Read Only Memory (ROM), Random Access Memory (RAM), disk drive storage, optical storage, removable storage and/or the like.

The memory 112 includes an operating system 114, a software development kit (SDK) 116, a DRM encryption module 118, a DRM enforcement module 120, a plurality of user accounts 122, a plurality of digital assets 124, a dynamic link library (DLL) 126 and a DLL injection module 128. The operating system 114 may include various commercially known operating systems. The memory 112 is optionally organized into one or more directories, not specifically shown, for storing the plurality of digital assets 124.

The client 104 is a computing device, for example a desktop computer, laptop, tablet computer, and the like. The client 104 includes a Central Processing Unit (CPU) 130, support circuits 132, and a memory 134. The CPU 130 may include one or more commercially available microprocessors or microcontrollers that facilitate data processing and storage. The various support circuits 132 facilitate the operation of the CPU 130 and include one or more clock circuits, power supplies, cache, input/output circuits, and the like. The memory 134 includes at least one of Read Only Memory (ROM), Random Access Memory (RAM), disk drive storage, optical storage, removable storage and/or the like.

The memory 134 includes an operating system 136, a viewer application 138, a dynamic link library (DLL) 140, and optionally, a DLL injection module 142, one or more digital assets 144, and optionally, a DRM encryption module 146. The viewer application 138 may be any application, such as ADOBE ACROBAT that is used to view a digital asset 144.

The network 106 includes a communication system that connects computers (or devices) by wire, cable, fiber optic and/or wireless link facilitated by various types of well-known network elements, such as hubs, switches, routers, and the like. The network 106 may be a part of the Intranet using various communications infrastructure, such as Ethernet, Wi-Fi, a personal area network (PAN), a wireless PAN, Bluetooth, Near field communication, and the like.

The SDK 116 is used to create the DRM encryption module 118, on the DRM server 102. The DRM encryption module 118 may be developed as a process on the DRM server 102 or as a service to encrypt digital assets 124. The DRM encryption module 118 may also be stored as DRM encryption module 146 on the client 104 for use in encrypting digital assets 144 on the client 104. The DRM encryption module 118 encrypts digital assets 124 in a same manner irrespective of file format, thus making the DRM encryption module 118 file format agnostic. The DRM encryption module 118 may provide options such as auto-protecting all digital assets 124 of a particular file format, protecting all digital assets 124 stored in a particular directory of the memory 114, and the like. For example, in a graphic design company, all images developed by the company's designers and stored as PDFs may be proprietary to the company. As such, the DRM encryption module 118 may be written to provide an option to automatically encrypt all digital assets 124 of file type PDF. In addition, the company may wish to encrypt all digital assets 124 in, for example, an accounting directory, such that only accounting personnel may access those digital assets 124. As such, the DRM encryption module 118 may be written to provide an option to encrypt all digital assets 124 in a particular directory portion of memory 114. In some embodiments, storage of digital assets 124 may be in a memory remote from, but accessible by the server 102.

The SDK 116 is also used to create the DLL 126. The DLL 126 is installed on the client 104 as DLL 140. The DLL 140 includes function patches for DRM operating system functions, such as OpenFile, PrintFile, copy, cut, and the like. The DLL 140 intercepts calls made by the viewer application 138 to the operating system 136 that would have otherwise have been processed by the operating system 136. For example, may attempt to open a digital asset 124 on the client 104. When the DLL 140 intercepts a call from the viewer application 138, the DLL 140 performs DRM processing for the call. In the present example, the DLL 140 intercepts the OpenFile call. If the operating system 136 is a WINDOWS OS, the OpenFile call is a “CreateFile” call to the operating system 136.

The DLL 140 determines if the call is made for a file type that requires DRM processing. For example, the DLL 140 may be written to control the DRM of digital assets of type PDF and DOC, but not digital assets of type JPEG. If the digital asset is not a file type that requires DRM, in this example, a JPEG, then the DLL 140 calls the original, unpatched function to open the JPEG. However, if the file type is one that requires DRM, the DLL 140 then determines whether the digital asset 124 is encrypted. If the digital asset 124 is not encrypted, the DLL 140 calls the original, unpatched function. However, if the digital asset 124 is encrypted, the DLL 140 authenticates the user who is trying to open the digital asset 124.

The DLL 140 calls the DRM enforcement module 120 to request authentication of the user. The DRM enforcement module 120 accesses the user account 122 to authenticate the user and determine whether the user has permission to perform the requested function, in this example, a “CreateFile” function. If the DRM enforcement module 120 determines that the user has permission to access the digital asset, the DRM enforcement module 120 returns an encryption key to the DLL 140 in response to the request. However, if the DRM enforcement module 120 determines that the user does not have permission, the DRM enforcement module 120 returns an error message to the DLL 140, which may be passed to the viewer application 138.

If the user has permission and the DLL 140 receives the encryption key, the DLL 140 decrypts the digital asset 124 using the key and stores the decrypted digital asset 124 in memory 134 as digital asset 144 for use by the user. The DLL 140 returns a memory file pointer to the digital asset 144 to the viewer application 138. The memory file pointer to the digital asset 144 and the encryption key may be stored in a global data structure such that the pointer may be passed to other calls for use, such as ReadFile, WriteFile, CloseFile, and the like. When the user saves or closes the digital asset 144, the DLL 140 encrypts the digital asset 144. If the digital asset 144 was retrieved from the DRM server 102, the DLL 140 sends it back to the DRM server 102 for storage as a digital asset 124. If the digital asset 144 was originally stored on the client 104, the DLL 140 simply encrypts the digital asset 144 and stores the digital asset 144 locally in memory 134.

In order to have the operation system calls from the viewer application 138 intercepted by the DLL 140, the DLL 140 must be “injected” into the viewer application 138. Injection places a piece of code (i.e., the DLL 140) into the viewer application 138 in order to replace a function definition in the viewer application 138, with the custom (i.e. DRM) functions of the DLL 140. The SDK 116 creates a DLL injection module 128 that injects the DLL 140 into the viewer application 138 when the viewer application 138 starts. The DLL injection module 128 may use any mechanism for injecting the DLL 140 into the viewer application 138. For example, the DLL 140 may be injected using a registry on WINDOW, with APIs such as SetWindowsHookEx, and the like.

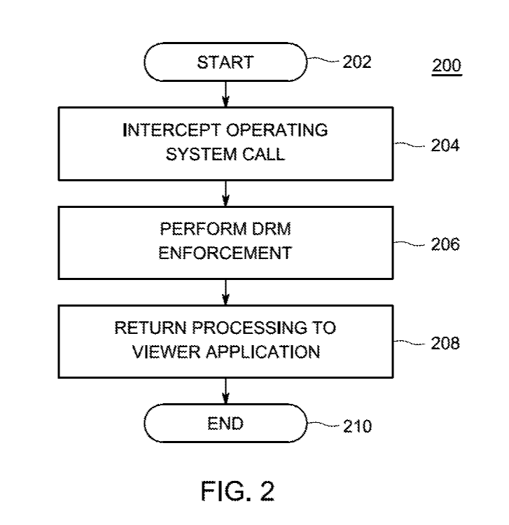

FIG. 2 depicts a flow diagram of a method 200 for digital rights management that is file type and viewer application agnostic as performed by the DLL 140 of FIG. 1, according to one or more embodiments. The method 200 intercepts operating system calls from a viewer application and performs DRM processing for the intercepted call. The method 200 starts at step 202 and proceeds to step 204.

At step 204, the method 200 intercepts a call from the viewer application for performance of a function in response to a user requested action on a digital asset. The digital asset may be a file stored by a company in a location accessible by a plurality of users. Alternatively, the digital asset may be a file stored locally on a user's device. The user may, for example, request to open the digital asset. The viewer application sends a FileOpen call to the operating system supporting the viewer application to open the digital asset. The method 200 intercepts the call and proceeds to step 206.

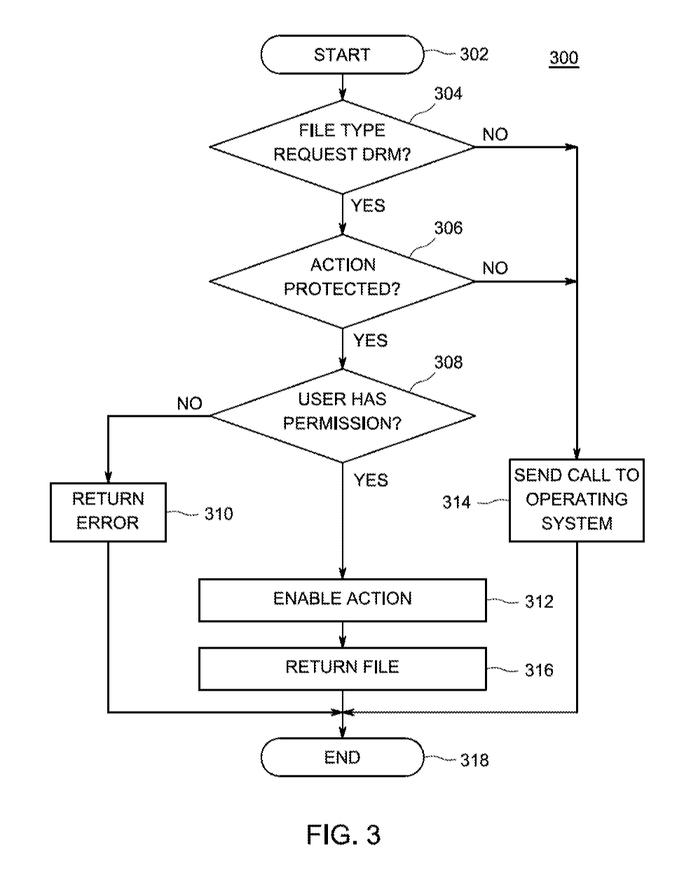

At step 206, the method 200 performs DRM enforcement for the digital asset as described in further detail with respect to FIG. 3, below. The method 200 proceeds to step 208, where the method 200 returns processing functions to the viewer application. If the user was granted permission to perform the desired request, in the present example, a FileOpen request, a file pointer to the decrypted digital asset is returned to the viewer application such that the viewer application may provide access to the user. However, if permission was not granted to perform the desired request, an error is returned to the viewer application. The method 200 proceeds to step 210 and ends.

FIG. 3 depicts a flow diagram of a method 300 for performing DRM enforcement as performed by the DLL 140 of FIG. 1, according to one or more embodiments. The method 300 determines whether a user has permission to perform a desired action on a digital asset, and if so, decrypts the digital asset for user by the user. The method 300 starts at step 302 and proceeds to step 304.

At step 304, the method 300 determines whether a file type of a digital asset is a file type that requires DRM enforcement. For example, the method 300 may perform DRM enforcement on PDF files, but not on JPEG files. If the method 300 determines that the file type of the digital asset is not a file type that requires DRM enforcement, the method 300 proceeds to step 314. However, if at step 304, the method 300 determines that the file type of the digital asset is a file type that requires DRM enforcement, the method 300 proceeds to step 306.

At step 306, the method 300 determines whether the digital asset has rights that protect it from the desired action. For example, if the user request is to print the digital asset, the method 300 determines whether the print functionality of the digital asset is disabled. Similarly, if the user request is to open the digital asset, the method 300 determines whether the digital asset is encrypted. If the user request is to perform a cut or copy action on the digital asset, the method 300 determines whether text selection functionality of the digital asset is disabled. If the method 300 determines that the desired action is not protected, the method 300 proceeds to step 314. At step 314, the method 300 sends the user request to perform the desired action to the operating system and then proceeds to step 318. However, if at step 306 the method 300 determines that the desired action is protected, the method 300 proceeds to step 308.

At step 308, the method 300 determines whether the user has permission to perform the desired action. For example, a user may have permission to open a digital asset, but not have permission to print the digital asset. The method 300 facilitates sending a request to a DRM server to authenticate the user and determine whether the user has permission to perform the desired action. If the method 300 receives, in response to the request, an indication that the user does not have permission to perform the desired function, the method 300 proceeds to step 310. At step 310, the method 300 returns an error, for example, indicating that permission was denied and proceeds to step 316. However, if at step 308, the user has permission to perform the desired action, the method 300 receives an indication that permission was granted. For example, if the user requested a FileOpen, the method 300 receives a decryption key as indication that permission was granted. Typically, the decryption key is the encryption key that was used to encrypt the digital asset.

If the method 300 determines that the user has permission to perform the desired action, the method 300 proceeds to step 312, where the method 300 enables the action. For example, if the user request to print the digital asset is granted, the method 300 enables printing of the digital asset. If the user request to perform cut or copy on the digital asset is granted, the method 300 enables text selection.

If the user request is to open the digital asset is granted, the method 300 uses an encryption key received in response to the request and decrypts the digital asset. The method 300 stores the decrypted digital asset along with a memory pointer to the decrypted digital asset as well as the encryption key. If the user request is to save or close the digital asset, the method 300 uses the encryption key to encrypt the digital asset before the method 300 sends a request to the DRM server to store the digital asset if the digital asset was originally stored on the DRM server or stores the digital asset locally if the digital asset was originally stores on the user's device. The method 300 proceeds to step 316, where the method 300 returns the digital asset with the requested action enabled.

The method 300 proceeds to step 318 and ends.

The embodiments of the present invention may be embodied as methods, apparatus, electronic devices, and/or computer program products. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer implemented method comprising:
intercepting processing of one or more operating system calls from a viewer application, wherein each of the one or more operating system calls requests performance of a function on a digital asset of a plurality of digital assets subject to digital rights management (DRM);
performing DRM enforcement of the digital asset with respect to the requested function; and
returning processing of the digital asset to the viewer application.

2. The method of claim 1, wherein the plurality of digital assets is protected, such that access to the plurality of digital assets is restricted to users with varying permissions.

3. The method of claim 2, wherein the plurality of digital assets are encrypted in a same manner irrespective of a file type of each digital asset in the plurality of digital assets.

4. The method of claim 1, wherein performing DRM enforcement comprises:
determining if a file type of a digital asset is of a type that requires DRM enforcement;
determining, when the file type of the digital asset is of the type that requires DRM enforcement, whether a requested function is protected for the digital asset;
determining, when the requested function is protected, whether a user requesting the requested function has permission to perform the requested function; and
enabling the requested function when the user has permission to perform the requested function or returning an error when the user does not have permission to perform the requested function.

5. The method of claim 4, wherein when the requested function is to open the digital asset, enabling the requested function comprises:
requesting an encryption key for the digital asset;
decrypting the digital asset using the encryption key; and
storing the digital asset and the encryption key.

6. The method of claim 5, further comprising,
encrypting the digital asset using the encryption key when the requested function is to either one of save or close the digital asset; and
providing the encrypted digital asset for storage.

7. The method of claim 4, further comprising:
sending a request to perform the requested function to an operating system when the file type of the digital asset is not of a type that requires DRM enforcement or when the requested function is not protected for the digital asset.

8. An apparatus for digital rights management that is file type and viewer application agnostic comprising:
a computer having one or more processors and further comprising:
a dynamic link library for intercepting processing of one or more operating system calls from a viewer application, wherein each of the one or more operating system calls requests performance of a function on a digital asset of a plurality of digital assets subject to digital rights management (DRM); performing DRM enforcement of the digital asset with respect to the requested function; and returning processing of the digital asset to the viewer application.

9. The apparatus of claim 8 wherein the plurality of digital assets are encrypted in a same manner irrespective of a file type of each digital asset in the plurality of digital assets.

10. The apparatus of claim 8, wherein performing DRM enforcement comprises:
determining if a file type of a digital asset is of a type that requires DRM enforcement;
determining, when the file type of the digital asset is of the type that requires DRM enforcement, whether a requested function is protected for the digital asset;
determining, when the requested function is protected, whether a user requesting the requested function has permission to perform the requested function; and
enabling the requested function when the user has permission to perform the requested function or returning an error when the user does not have permission to perform the requested function.

11. The apparatus of claim 10, wherein when the requested function is to open the digital asset, enabling the requested function comprises:
requesting an encryption key for the digital asset;
decrypting the digital asset using the encryption key; and
storing the digital asset and the encryption key.

12. The apparatus of claim 11, further comprising,
encrypting the digital asset using the encryption key when the requested function is to either one of save or close the digital asset; and
providing the encrypted digital asset for storage.

13. The apparatus of claim 10, further comprising:
sending a request to perform the requested function to an operating system when the file type of the digital asset is not of a type that requires DRM enforcement or when the requested function is not protected for the digital asset.

14. A non-transient computer readable medium for storing computer instructions that, when executed by at least one processor causes the at least one processor to perform a method for digital rights management that is file type and viewer application agnostic comprising:
intercepting processing of one or more operating system calls from a viewer application, wherein each of the one or more operating system calls requests performance of a function on a digital asset of a plurality of digital assets subject to digital rights management (DRM);
performing DRM enforcement of the digital asset with respect to the requested function; and
returning processing of the digital asset to the viewer application.

15. The computer readable medium of claim 14, wherein the plurality of digital assets is protected, such that access to the plurality of digital assets is restricted to users with varying permissions.

16. The computer readable medium of claim 15, wherein the plurality of digital assets are encrypted in a same manner irrespective of a file type of each digital asset in the plurality of digital assets.

17. The computer readable medium of claim 14, wherein performing DRM enforcement comprises:
determining if a file type of a digital asset is of a type that requires DRM enforcement;
determining, when the file type of the digital asset is of the type that requires DRM enforcement, whether a requested function is protected for the digital asset;
determining, when the requested function is protected, whether a user requesting the requested function has permission to perform the requested function; and
enabling the requested function when the user has permission to perform the requested function or returning an error when the user does not have permission to perform the requested function.

18. The computer readable medium of claim 17, wherein when the requested function is to open the digital asset, enabling the requested function comprises:
requesting an encryption key for the digital asset;
decrypting the digital asset using the encryption key; and
storing the digital asset and the encryption key.

19. The computer readable medium of claim 18, further comprising,
encrypting the digital asset using the encryption key when the requested function is to either one of save or close the digital asset; and
providing the encrypted digital asset for storage.

20. The computer readable medium of claim 17, further comprising:
sending a request to perform the requested function to an operating system when the file type of the digital asset is not of a type that requires DRM enforcement or when the requested function is not protected for the digital asset.
